(19) United States
(12) Patent Application Publication
(10) Pub. No.: US 2025/0341995 A1
(43) Pub. Date: Nov. 6, 2025

(54) STORAGE MEDIUM STORING PROGRAM, ELECTRONIC DEVICE, METHOD PERFORMED IN ELECTRONIC DEVICE, AND PRINT SYSTEM

(71) Applicant: BROTHER KOGYO KABUSHIKI KAISHA, Nagoya (JP)

(72) Inventor: Satoshi WATANABE, Nagoya (JP)

(21) Appl. No.: 19/180,554

(22) Filed: Apr. 16, 2025

(30) Foreign Application Priority Data
May 1, 2024 (JP) 2024-074362

(51) Int. Cl. G06F 3/12; G06Q 30/06

(52) U.S. Cl. CPC G06F 3/1235; G06F 3/121; G06F 3/1219; G06F 3/1273; G06Q 30/06

(57) ABSTRACT

A set of program instructions, when executed by the controller, causes the electronic device to perform, in a case where a number of printed sheets in a printer in a current unit period satisfies a particular condition, notifying about a change of a plan of a print service from a first plan to a second plan. The particular condition is a condition of a number of sheets relating to the first plan corresponding to the current unit period. The print service is that, by paying a basic fee of the plan, in a case where the number of printed sheets at an end of a unit period does not exceed the upper limit number, a consumable to be used in the printer in the unit period is provided. The upper limit number of the second plan is larger than the upper limit number of the first plan.

### REFERENCE TO RELATED APPLICATIONS

This application claims priority from Japanese Patent Application No. 2024-074362 filed on May 1, 2024. The entire content of the priority application is incorporated herein by reference.

### BACKGROUND ART

A service is known in which, when a remaining amount of a consumable such as toner or ink in a printer becomes small, the consumable is automatically ordered and delivered.

### SUMMARY

When the remaining amount of the consumable becomes small, the printer displays a screen for prompting a delivery contract if such a delivery contract of the consumable is not set. According to such a printer, a delivery contract of consumables is recommended to a user at an appropriate timing.

One aspect of the present disclosure provides a new method for a print service that provides consumables to be used in printing on a printer.

According to one aspect, this specification discloses a non-transitory computer-readable storage medium storing a set of program instructions for an electronic device including a controller. The set of program instructions, when executed by the controller, causes the electronic device to perform, in a case where a number of printed sheets in a printer in a current unit period satisfies a particular condition, notifying about a change of a plan of a print service from a first plan to a second plan. The printer is a target of the print service. The print service has a plurality of plans including the first plan and the second plan. The particular condition is a condition of a number of sheets relating to the first plan corresponding to the current unit period. Thus, a subscriber of the print service is notified about the change of the plan. Any one of the plurality of plans of the print service is set to each of unit periods including the current unit period. Each of the plurality of plans has an upper limit number of sheets. Each of the plurality of plans has a basic fee corresponding to the upper limit number such that the basic fee increases as the upper limit number increases. The print service is that a consumable to be used in the printer in a unit period is provided by paying the basic fee of the plan corresponding to the unit period, in a case where the number of printed sheets at an end of the unit period does not exceed the upper limit number of the plan. The first plan has a first upper limit number as the upper limit number. The second plan has a second upper limit number as the upper limit number. The second upper limit number is larger than the first upper limit number. According to another aspect, the present disclosure may be implemented in a form of an electronic device such as a server, an information processing apparatus, and a printer. According to still another aspect, the present disclosure may be implemented in a form of a method performed in an electronic device. According to still another aspect, the present disclosure may be implemented in a form of a print system including a server, an information processing apparatus, and a printer.

According to the above configuration, when the number of printed sheets in a unit period temporarily increases, the plan of the print service may be changed accordingly. Thus, the print service is provided in a manner appropriate for the user.

### BRIEF DESCRIPTION OF DRAWINGS

FIG. 1A is a block diagram of a print system.

FIG. 1B is a block diagram of an operation server.

FIG. 2A is a block diagram of an information processing apparatus.

FIG. 2B is a block diagram of a printer.

FIG. 3 is a flowchart of a plan change process.

FIG. 4 is a flowchart of a plan return process.

FIG. 5A is a block diagram of an information processing apparatus.

FIG. 5B is a block diagram of a printer.

### DESCRIPTION

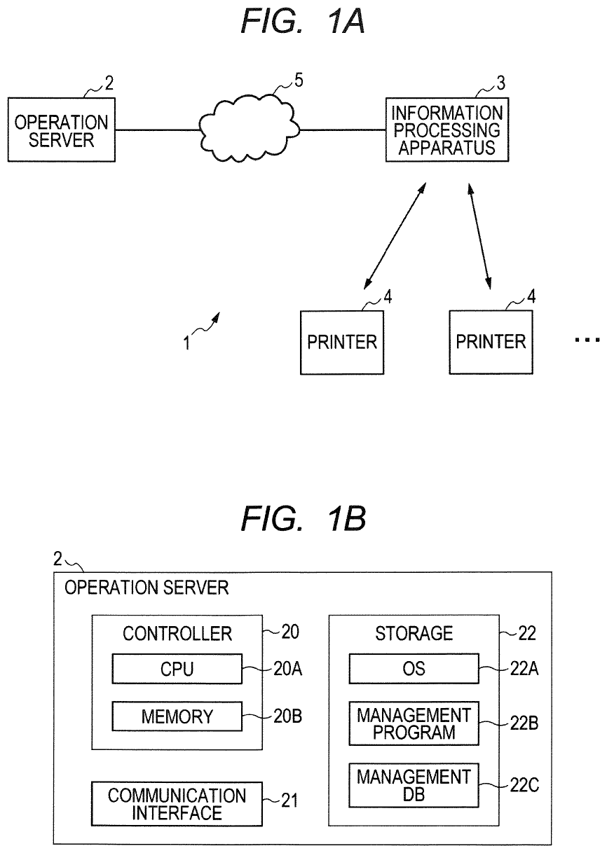

Exemplary embodiments of the present disclosure will now be described. A print system 1 according to a first embodiment includes an operation server 2, an information processing apparatus 3, and a printer 4. The operation server 2 and the information processing apparatus 3 are connected to a wide area network 5 such as the Internet. The printer 4 is configured to communicate with the information processing apparatus 3, and performs printing in response to an instruction from the information processing apparatus 3. The print system 1 is configured to provide a service (hereinafter, referred to as a print service) for printing performed by the printer 4 (see FIG. 1A).

The print service is a service for providing consumables to be used in printing by the printer 4 designated by a subscriber to the print service. In the present embodiment, as an example, one printer 4 is a target of the print service, but a plurality of printers 4 may be targets of the print service as described later. The consumable may be, for example, a coloring agent such as ink and toner, and a print medium such as paper. For example, the print service may be a subscription service in which, by paying a basic fee for each unit period, consumables to be used by the printer 4 in each unit period is provided in a case where a total number of printed sheets in each unit period does not exceed an upper limit number. Hereinafter, the number of sheets used for printing in the printer 4 is referred to as a number of printed sheets. The total number of printed sheets means the total number of printed sheets in a unit period. The basic fee may be a flat rate fee or a fee that varies due to some factor while being based on the flat rate fee.

The unit period may be a month or a year, for example. That is, in the print service, by paying a basic fee each month (or each year), in a case where the total number of printed sheets of each month (or each year) does not exceed the upper limit number, consumables to be used by the printer 4 each month (or each year) may be provided.

The print service has a plurality of plans having different upper limit numbers of sheets, which are selectable by a subscriber to the print service. In each unit period, any one of the plans is set, and the print service is provided according to the set plan. The larger the upper limit number of the plan, the higher the basic fee for each unit period.

In the print service, in a case where the total number of printed sheets in a unit period exceeds the upper limit number, consumables may be provided in the unit period by paying an excess fee corresponding to a number of excess sheets which is a difference between the total number of printed sheets and the upper limit number.

The operation server 2 is configured as a server on a cloud. The operation server 2 is configured to communicate with the information processing apparatus 3 via the wide area network 5, and to perform a process for providing a print service (see FIG. 1B). For example, the operation server 2 may perform a process for a procedure for subscribing to the print service, a process for charging a subscriber of the print service, and a process for arranging supply of consumables to the subscriber. The operation server 2 may be configured to communicate with the printer 4, which is a target of the print service, via the wide area network 5.

The operation server 2 includes a controller 20, a communication interface 21, and a storage 22. The controller 20 includes a CPU 20A and a memory 20B. The CPU 20A performs processing in accordance with a program loaded in the memory 20B. The memory 20B may include a semiconductor memory such as a ROM, a RAM, an NVRAM, and a flash memory, for example.

The communication interface 21 is a unit for accessing the wide area network 5, and communicates with, for example, an apparatus such as the information processing apparatus 3 via the wide area network 5. The storage 22 has a configuration as an example of a non-transitory computer-readable storage medium. The storage 22 is a unit for storing programs to be executed by the CPU 20A and various kinds of data, and may be configured as a storage such as an HDD (Hard Disk Drive) and an SSD (Solid State Drive).

The storage 22 stores a program installed in the operation server 2. As an example, the storage 22 stores an operating system (hereinafter, OS) 22A and a management program 22B that operates on the OS 22A. The management program 22B will be described in detail later.

The storage 22 stores a management database (DB) 22C for managing the print service. The management database 22C includes a plurality of management information (details will be described later), and each management information corresponds to a subscriber to the print service.

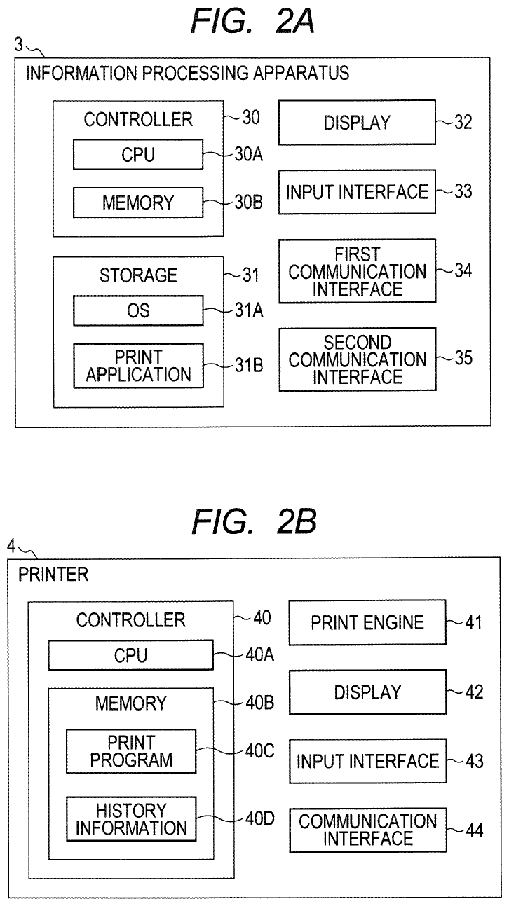

The information processing apparatus 3 is configured as a mobile terminal such as a smartphone, a tablet terminal and a notebook computer, or a desktop PC, for example (see FIG. 2A). The information processing apparatus 3 is configured to communicate with the printer 4 and to perform printing by the printer 4. The information processing apparatus 3 may communicate with the printer 4 via a local area network or may directly communicate with the printer 4.

The information processing apparatus 3 includes a controller 30, a storage 31, a display 32, an input interface 33, a first communication interface 34, and a second communication interface 35. The controller 30 includes a CPU 30A and a memory 30B. The CPU 30A performs processing in accordance with a program loaded in the memory 30B. The memory 30B may include, for example, a semiconductor memory such as a ROM, a RAM, an NVRAM, and a flash memory.

The storage 31 has a configuration as an example of a non-transitory computer-readable storage medium. The storage 31 is a unit for storing programs executed by the CPU 30A and various kinds of data, and may be configured as a storage such as an HDD or an SSD.

The storage 31 stores programs that are installed in the information processing apparatus 3. As an example, the storage 31 stores an operating system (hereinafter, OS) 31A and a print application 31B that operates on the OS 31A.

The print application 31B is configured to perform a process for receiving a print service. In addition, the print application 31B may have a function of causing the printer 4 to perform printing. For example, the print application 31B may have a function of editing and generating a file including an image and/or characters in accordance with an instruction from a user, or may have a function of viewing such file. In addition, the print application 31B may be configured as, for example, a printer driver that controls the printer 4.

The display 32 is a unit that displays various images, and may be a liquid crystal display, for example. The input interface 33 includes one or more input devices for receiving an input operation of the user. The input interface 33 may include a keyboard, a mouse, and/or a touch panel, for example.

The first communication interface 34 is a unit for communicating with the printer 4. The first communication interface 34 may communicate with the printer 4 via a local area network, for example, or may directly communicate with the printer 4 in accordance with a standard such as USB (Universal Serial Bus) or Bluetooth, for example. The “Bluetooth” is a registered trademark of Bluetooth SIG, Inc.

The second communication interface 35 is a unit for accessing the wide area network 5, and communicates with, for example, an apparatus such as the operation server 2 via the wide area network 5.

The printer 4 has a function of printing an image on a print medium such as a sheet of paper based on print data received from the information processing apparatus 3 (see FIG. 2B). The printer 4 is not limited to this, and may have a function as a label printer that prints a label image on a tape-like print medium, or may be configured as a portable mobile printer. The printer 4 may be configured as a multifunction peripheral (MFP) having a scan function, a copy function, and a facsimile function in addition to a print function.

The printer 4 includes a controller 40, a print engine 41, a display 42, an input interface 43, and a communication interface 44. The controller 40 includes a CPU 40A and a memory 40B. The memory 40B may include, for example, a semiconductor memory such as a ROM, a RAM, an NVRAM, and a flash memory. A nonvolatile memory such as the ROM and the flash memory in the memory 40B stores a print program 40C for realizing various functions of the printer 4, and history information 40D, for example.

The CPU 40A performs processing in accordance with the print program 40C stored in the memory 40B, thereby integrally controlling the printer 4. The history information 40D is a record of printing performed by the printer 4. The history information 40D indicates a total number of printed sheets in each unit period in the past in the printer 4, a number of printed sheets up to the current time in the current unit period (hereinafter, referred to as current number of printed sheets), and a remaining number of sheets in the current unit period. The remaining number of sheets refers to the number of printable sheets before reaching an upper limit number for the current unit period. The remaining number of sheets is calculated by subtracting the current number of printed sheets from the upper limit number. The history information 40D indicates the remaining amount of the consumable of the printer 4 at the current time. The history information 40D is generated by the CPU 40A that performs processing in accordance with the print program 40C.

The print engine 41 includes a print mechanism of an inkjet type or electrophotographic type, for example, and prints an image on a print medium. The display 42 displays various kinds of information to the user.

The input interface 43 receives various input operations from the user. The input interface 43 may include a button and/or a touch panel, for example. The communication interface 44 is a unit for communicating with the information processing apparatus 3. The communication interface 44 may communicate with the information processing apparatus 3 via a local area network, for example, or may directly communicate with the information processing apparatus 3 in accordance with a standard such as USB or Bluetooth, for example.

The management program 22B will be described. The CPU 20A of the controller 20 of the operation server 2 is configured to perform a process for providing a print service by performing a process in accordance with the management program 22B installed in the operation server 2 (see FIG. 1B). Hereinafter, for convenience, the processing performed by the CPU 20A under the control of the management program 22B may be described as being performed by the management program 22B itself.

The management program 22B performs a process for a procedure for a new subscription to the print service. For example, in response to receiving a request for subscription to the print service via the information processing apparatus 3, the management program 22B generates an account corresponding to a new subscriber. The management program 22B acquires information of the subscriber from the information processing apparatus 3, generates management information corresponding to the account of the subscriber based on the information, and registers the management information in the management database 22C.

The management information may include the name and contact information of the subscriber, the print service and a plan of the print service to which the subscriber subscribes, and the model name, and identification information, for example, of the printer 4 that is the target of the print service (target printer). The subscriber may subscribe to one or more print services, and the target printer 4 is determined for each print service. That is, one or more print services may be subscribed to for one account. In addition, the management program 22B may terminate or add the print service, or change the plan of the print service, for example, in accordance with an instruction received from a subscriber via the information processing apparatus 3.

The management information may include usage record information of each subscribed print service. The usage record information is provided corresponding to each print service. The usage record information may include the total number of printed sheets in each unit period in the past in the printer 4 that is the target of the corresponding print service, the current number of printed sheets and the remaining number of sheets in the current unit period, and the remaining amounts of consumables of the printer 4 at the current time point.

The management program 22B acquires print information of the printer 4 which is the target of the print service in order to perform charging to a subscriber of the print service, and arrangement of supply of consumables, for example. The print information may include, for example, the current number of printed sheets and the remaining number of sheets in the printer 4, the remaining amounts of the consumables of the printer 4, and the total number of printed sheets in each unit period in the past.

The print information may be generated by the printer 4. In this case, the management program 22B may receive the print information from the printer 4 via the information processing apparatus 3. In a case where the printer 4 is configured to communicate with the operation server 2 via the wide area network 5, the management program 22B may receive the print information from the printer 4 via the wide area network 5. Alternatively, for example, the information processing apparatus 3 may generate the print information based on information acquired from the printer 4. In this case, the management program 22B may receive the print information from the information processing apparatus 3.

In response to receiving the print information, the management program 22B updates the usage record information included in the management information for the print service targeted for the printer 4 that is the transmission source of the print information, based on the print information.

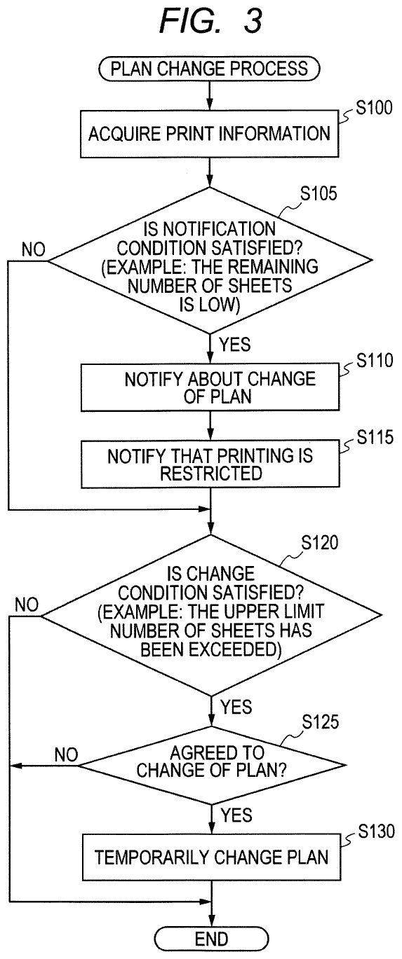

Next, a plan change process performed by the management program 22B will be described with reference to the flowchart of FIG. 3. The plan change process is performed at periodic timing in each unit period for individual print service to which a subscriber subscribes. In the plan change process, when the number of printed sheets in the unit period exceeds the upper limit number, the plan of the print service is temporarily changed to a plan having a larger upper limit number. Hereinafter, the plan originally selected in the print service corresponding to the plan change process is referred to as a first plan, and the plan after the change is referred to as a second plan. When the plan is temporarily changed to the second plan in the middle of the unit period, the print service is provided by assuming that the second plan has been selected from the beginning in the unit period.

In S100, the management program 22B acquires print information regarding the printer 4 (target printer 4) which is the target of the print service, updates usage record information of management information of the print service based on the print information, and proceeds to S105.

In S105, the management program 22B determines whether a notification condition is satisfied. In a case where a positive determination is made (S105: YES), the management program 22B proceeds to S110. In a case where a negative determination is made (S105: NO), the management program 22B proceeds to S120.

For example, the notification condition may be a condition that the current number of printed sheets exceeds a first upper limit number which is an upper limit number of sheets of the first plan, or may be a condition that the remaining number of sheets reaches a predetermined lower limit number of sheets. In these cases, it may be determined whether the notification condition is satisfied based on the print information acquired in S100.

The notification condition may be, for example, a condition that it is predicted that the total number of printed sheets in the current unit period exceeds the first upper limit number. In this case, for example, the prediction may be performed based on the total number of printed sheets in the past unit periods indicated by the usage record information of the management information of the print service. For example, when the current number of printed sheets exceeds a predetermined threshold and the average value of the total number of printed sheets in a plurality of most recent unit periods exceeds the first upper limit number, it may be predicted that the total number of printed sheets in the current unit period exceeds the first upper limit number. For example, in a case where the unit period is a month, when the current number of printed sheets exceeds the threshold and the total number of printed sheets in the same month of the previous year (or the average of the total number of printed sheets in the same month of a plurality of past years) exceeds the first upper limit number, it may be predicted that the total number of printed sheets in the current unit period exceeds the first upper limit number.

For example, the management program 22B may predict whether the total number of printed sheets in the current unit period exceeds the first upper limit number based on a planned print number of sheets. The planned print number of sheets means the planned print number of sheets in printing which the subscriber plans to perform in the current unit period by using the target printer 4. For example, when the current number of printed sheets exceeds a predetermined value and the planned print number of sheets exceeds the first upper limit number, the management program 22B may predict that the total number of printed sheets in the current unit period exceeds the first upper limit number.

The planned print number of sheets may be acquired based on an operation received from the user on the target printer 4 or on the information processing apparatus 3 configured to perform printing by the target printer 4 (hereinafter, referred to as a target information processing apparatus 3). The management program 22B may receive the planned print number of sheets from the target printer 4 or the target information processing apparatus 3 in a similar manner to the print information.

In S110, the management program 22B notifies the subscriber that the plan in the current unit period may be temporarily changed from the first plan to the second plan, and proceeds to S115. In S110, for example, the management program 22B may suggest, to the subscriber, temporarily changing the plan in the current unit period from the first plan to the second plan. The second upper limit number, which is the upper limit number of sheets of the second plan, is larger than the first upper limit number. The management program 22B may notify the subscriber about the remaining number of sheets in addition to or instead of the change of the plan.

For example, the notification may be performed by the following notification procedure. That is, the management program 22B may transmit a command to the target information processing apparatus 3 and perform the notification via the display 32 or a speaker (not shown) of the target information processing apparatus 3. For example, in a case where the target printer 4 is connected to the wide area network 5, the management program 22B may transmit a command to the target printer 4 and perform the notification via the display 42 or a speaker (not shown) of the target printer 4. For example, the management program 22B may transmit an electronic mail for the notification to an e-mail address of the subscriber.

Further, in S110, the management program 22B queries the subscriber whether to agree to change the plan of the print service from the first plan to the second plan, and receives a response to the query.

For example, the query and reception of the response may be performed by the following confirmation procedure. That is, the management program 22B may query via the target information processing apparatus 3 or the target printer 4 in the same manner as the notification procedure. The target information processing apparatus 3 or the target printer 4 that has made the query may receive a response to the query from the subscriber via the input interface and transmit the response to the management program 22B.

In S115, the management program 22B notifies that printing in the target printer 4 in the current unit period is restricted by the above-described notification procedure, and proceeds to S120. For example, the management program 22B may notify the user that printing by the target printer 4 is restricted when the remaining period until the end of the unit period is shorter than a threshold and the end time of the unit period is approaching. For example, the management program 22B may notify the user that printing by the target printer 4 is stopped when the number of printed sheets reaches the upper limit number.

In S120, the management program 22B determines whether a change condition is satisfied. In a case where a positive determination is made (S120: YES), the management program 22B proceeds to S125. In a case where a negative determination is made (S120: NO), the management program 22B ends the process.

For example, the change condition may be a condition that the current number of printed sheets exceeds the first upper limit number. In this case, it may be determined whether the change condition is satisfied based on the current number of printed sheets indicated by the print information acquired in S100.

Alternatively, the change condition may be, for example, a condition that the current number of printed sheets exceeds the first upper limit number and an excess fee in the current unit period exceeds a price difference obtained by subtracting the basic fee of the first plan from the basic fee of the second plan (hereinafter, also referred to as a price difference of the basic fee). In this case, the management program 22B may calculate the number of excess sheets based on the current number of printed sheets indicated by the print information acquired in S100 and the first upper limit number, and calculate the excess fee based on the number of excess sheets.

In S125, the management program 22B determines whether the subscriber has agreed to change the plan of the print service from the first plan to the second plan, based on the response received in S110. In a case where a positive determination is made (S125: YES), the management program 22B proceeds to S130. In a case where a negative determination is made (S125: NO), the management program 22B ends the process.

In S130, the management program 22B changes the management information of the print service to temporarily change the plan of the print service from the first plan to the second plan, and ends the process. In this way, the print service is provided for the current unit period, assuming that the second plan has been selected from the beginning. Thus, although the plan is changed from the first plan to the second plan in the middle of the current unit period, the basic fee for the current unit period is a fee for the second plan.

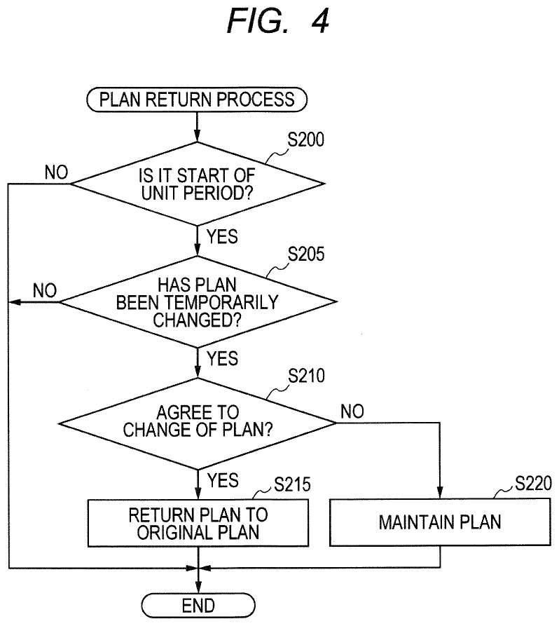

Next, a plan return process performed by the management program 22B will be described with reference to the flowchart of FIG. 4. The plan return process is performed at periodic timing for individual print service to which a subscriber subscribes. In the plan return process, the plan temporarily changed by the plan change process is returned from the second plan to the original first plan.

In S200, the management program 22B determines whether it is the start time of a new unit period. In a case where a positive determination is made (S200: YES), the management program 22B proceeds to S205. In a case where a negative determination is made (S200: NO), the management program 22B ends the process.

In S205, the management program 22B determines whether the plan of the print service has been temporarily changed to the second plan by the plan change process, based on the management information of the print service. In a case where a positive determination is made (S205: YES), the management program 22B proceeds to S210. In a case where a negative determination is made (S205: NO), the management program 22B ends the process.

In S210, the management program 22B confirms with the subscriber as to whether the subscriber agrees to return the plan of the print service from the second plan to the first plan by the above-described confirmation procedure, and receives a response to the query. In a case where a response that the plan change is agreed is obtained (S210: YES), the management program 22B proceeds to S215. In a case where a response that the plan change is agreed is not obtained (S210: NO), the management program 22B proceeds to S220.

In S215, the management program 22B changes the management information of the print service such that the plan of the print service is returned from the second plan to the first plan, and ends the process. Thus, after the unit period in which the plan is temporarily changed to the second plan, the print service is provided in a state where the first plan is selected.

In S220, the management program 22B changes the management information of the print service such that the second plan of the print service is continued (maintained), and ends the process. Thus, even after the unit period in which the plan is temporarily changed to the second plan, the print service is provided in a state where the second plan is selected.

A second embodiment will be described. The print system 1 of the second embodiment is different from the first embodiment in that a plurality of printers 4 are targets of one print service, but other parts are the same as those of the first embodiment (see FIGS. 1A to 4). In the print service of the second embodiment, by paying a basic fee for the plurality of target printers 4, consumables to be used in a unit period are provided to the target printer 4 of which the total number of printed sheets in the unit period does not exceed the upper limit number.

In the print service of the second embodiment, when the total number of printed sheets in the unit period in a certain target printer 4 exceeds the upper limit number, consumables may be provided to the target printer 4 by paying an excess fee corresponding to the excess number of sheets which is a difference between the upper limit number and the total number of printed sheets in the target printer.

In the second embodiment, the management program 22B temporarily changes the plan of the print service from the first plan to the second plan when the number of printed sheets in the unit period exceeds the upper limit number in at least one of the plurality of target printers 4 of the print service. That is, when the number of printed sheets in the unit period exceeds the upper limit number in N or more target printers 4, the plan is changed. Here, threshold Nis an integer larger than or equal to 1. The threshold N is determined as appropriate.

Hereinafter, the print system 1 of the second embodiment will be described focusing on differences from the first embodiment. In the second embodiment, the management program 22B performs a plan change process similar to the first embodiment (see FIG. 3) in order to temporarily change the plan of the print service. However, in the second embodiment, since the plurality of printers 4 are targets of the print service, a part of the plan change process is different from that of the first embodiment. The plan change process of the second embodiment will be described below with reference to FIG. 3, focusing on the differences from the first embodiment.

In S100, the management program 22B acquires print information for the plurality of target printers 4, and updates the usage record information of the management information of the print service based on the acquired print information.

In S105, the management program 22B determines, for each target printer 4, whether the notification condition as in the first embodiment is satisfied. In a case where the notification condition is satisfied for N or more target printers 4 (S105: YES), the management program 22B proceeds to S110. In a case where the notification condition is not satisfied for N or more target printers 4 (S105: NO), the management program 22B proceeds to S120.

In S110, a process similar to the first embodiment is performed. The notification procedure of the second embodiment differs from that of the first embodiment in that notification may be performed via the plurality of target printers 4.

In S115, the management program 22B notifies that printing in the target printers 4 in the current unit period is restricted, similarly to the first embodiment. In addition, the management program 22B notifies the user about the target printer 4 having a relatively large remaining number of sheets and suggests printing by the target printer 4. For example, the target printer 4 that does not satisfy the notification condition may be suggested, or M (M is an integer of 1 or more) target printers 4 selected in descending order of the remaining number of sheets (that is, having a larger remaining number of sheets) may be suggested. The notification and the suggestion are performed by a notification procedure similar to that of S110.

In S120, the management program 22B determines whether a change condition is satisfied. The change condition may be, for example, a condition that the current number of printed sheets by N or more target printers 4 exceeds the first upper limit number. The change condition may be, for example, a condition that the current number of printed sheets exceeds the first upper limit number and the excess fee exceeds the price difference of the basic fee in the N or more target printers 4. Thus, in S120, the management program 22B determines whether the current number of printed sheets exceeds the first upper limit number for each target printer 4, and the excess fee is calculated based on the number of excess sheets in each target printer 4 in which the current number of printed sheets exceeds the first upper limit number.

In S125 and S130, in a case where the subscriber's confirmation is obtained (that is, in a case where the subscriber has agreed to the change of the plan), the plan of the print service is temporarily changed from the first plan to the second plan.

In the second embodiment, the management program 22B performs a plan return process (see FIG. 4) similar to that of the first embodiment in order to return the plan of the print service, which has been temporarily changed to the second plan, to the first plan.

A third embodiment will be described. The print system 1 of the third embodiment is different from the first embodiment in that the plan change process and the plan return process are performed by the print application 31B of the information processing apparatus 3 that controls the printer 4. The printer 4 is the target of the print service of which the plan is changed by these processes. However, the other parts of the print system 1 are the same as those in the first embodiment (see FIGS. 1A, 1B, and 2B to 5A).

In the third embodiment, the CPU 30A of the controller 30 of the information processing apparatus 3 operates in accordance with the print application 31B installed in the information processing apparatus 3 to perform the plan change process and the plan return process. Hereinafter, for convenience, the processing performed by the CPU 30A under the control of the print application 31B may be described as being performed by the print application 31B itself.

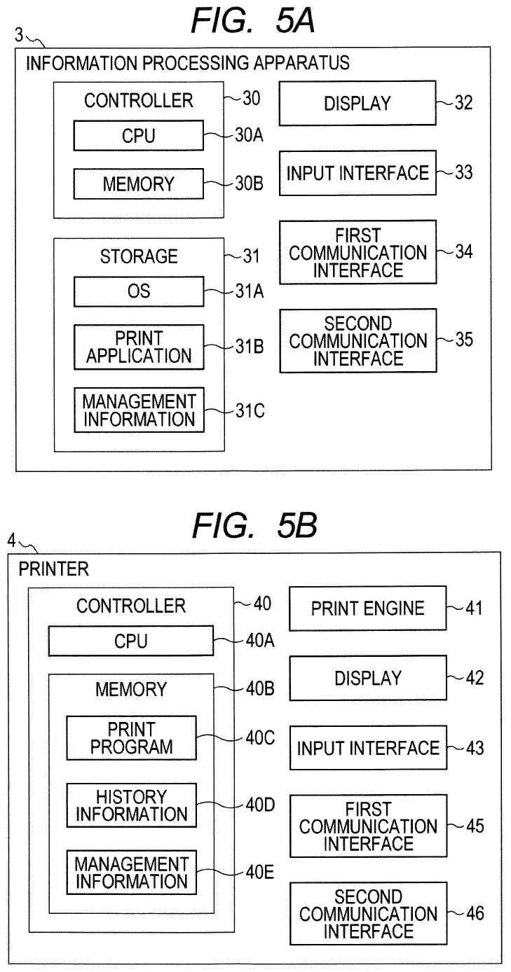

The information processing apparatus 3 of the third embodiment is different from that of the first embodiment in that management information 31C is stored in the storage 31 (see FIG. 5A). The management information 31C is information relating to the print service. The management information 31C may include the name and contact information of the subscriber, the print service to which the subscriber subscribes and the plan of the print service, and the model name and identification information of the target printer 4 of the print service.

Hereinafter, the print system 1 of the third embodiment will be described focusing on the differences from the first embodiment.

Next, a plan change process performed by the print application 31B will be described with reference to the flowchart of FIG. 3. The plan change process of the third embodiment is similar to that of the first embodiment, but is different from that of the first embodiment in that the plan change process is performed by the print application 31B and in part of the process. The plan change process of the third embodiment will be described below, focusing on the differences from the first embodiment.

In S100, the print application 31B receives the history information 40D from the target printer 4, and acquires the total number of printed sheets in the past unit periods, the current number of printed sheets, and the remaining number of sheets based on the history information 40D.

In S105, the print application 31B determines whether a notification condition similar to that of the first embodiment is satisfied. In a case where the notification condition is a condition that it is predicted the total number of printed sheets in the current unit period exceeds the first upper limit number, the print application 31B may perform the prediction based on the history information 40D received in S100. Alternatively, for example, the management program 22B may predict whether the total number of printed sheets in the current unit period exceeds the first upper limit number based on the planned print number of sheets. In this case, the print application 31B may acquire the planned print number of sheets based on an operation received via the input interface 33. Further, the planned print number of sheets may be acquired based on an operation received from the user in the target printer 4, and the print application 31B may receive the planned print number of sheets from the target printer 4.

In S110, the print application 31B performs a process similar to that of the first embodiment. In the notification procedure of the third embodiment, the print application 31B may perform notification via the display 32 or a speaker (not shown), or may transmit a command to the target printer 4 and perform notification via the display 42 or a speaker (not shown) of the target printer 4. In the confirmation procedure of the third embodiment, the print application 31B may query by the above-described notification procedure. The print application 31B may receive a response to the query from the subscriber via the input interface 33. Alternatively, the target printer 4 may receive a response from the subscriber via the input interface 43, and the print application 31B may receive the response from the target printer 4.

In S115, the print application 31B notifies that printing in the target printer 4 in the current unit period is restricted by the notification procedure described above, similarly to the first embodiment.

In S120, the print application 31B determines whether a change condition similar to that of the first embodiment is satisfied. The change condition may be, for example, a condition that the current number of printed sheets exceeds the first upper limit number. In this case, the print application 31B may determine whether the change condition is satisfied based on the history information 40D received in S100. Alternatively, the change condition may be a condition that the current number of printed sheets exceeds the first upper limit number and the excess fee in the current unit period exceeds the price difference of the basic fee. In this case, the print application 31B may calculate the excess number of sheets based on the history information 40D, and may calculate the excess fee based on the excess number of sheets and price information received from the management program 22B, for example.

In S125, the print application 31B determines whether the subscriber has agreed to change the plan of the print service from the first plan to the second plan, based on the response received in S110.

In S130, the print application 31B transmits a command to the management program 22B to instruct the management program 22B to temporarily change the plan of the print service from the first plan to the second plan, and ends the process. The print application 31B updates the management information 31C so as to reflect the temporary change from the first plan to the second plan of the print service. The management program 22B that has received the command changes the management information of the print service, thereby temporarily changing the plan of the print service from the first plan to the second plan.

Next, a plan return process performed by the print application 31B will be described with reference to the flowchart of FIG. 4. The plan return process of the third embodiment is similar to that of the first embodiment, but is different from that of the first embodiment in that the plan return process of the third embodiment is performed by the print application 31B and in part of the process. The plan return process of the third embodiment will be described below, focusing on the differences from the first embodiment.

In S200, the print application 31B determines whether it is the start time of a new unit period. In S205, the print application 31B determines whether the plan of the print service has been temporarily changed from the first plan to the second plan by the plan change process, based on the management information 31C.

In S210, the print application 31B queries the subscriber whether to agree to return the plan of the print service from the second plan to the first plan by the confirmation procedure described above, and receives a response to the query.

In S215, the print application 31B transmits a command to the management program 22B to instruct the management program 22B to return the plan of the print service from the second plan to the first plan, and updates the management information 31C accordingly, and ends the process.

In S220, the print application 31B transmits a command to the management program 22B to instruct the management program 22B to continue the second plan of the print service, and updates the management information 31C accordingly, and ends the process.

The management program 22B that has received the command changes the management information of the print service, and thereby, in response to an instruction from the print application 31B, returns the plan of the print service from the second plan to the first plan, or continues the second plan.

A fourth embodiment will be described. The print system 1 of the fourth embodiment is different from the third embodiment in that a plurality of printers 4 are targets of one print service, but other parts are the same as the third embodiment (see FIGS. 1A, 1B, and 2B to 5A). That is, the print service of the fourth embodiment is similar to that of the second embodiment. That is, by paying a basic fee, consumables to be used in a unit period are provided to the target printer 4 in which the total number of printed sheets in the unit period does not exceed the upper limit number, among the plurality of target printers 4. Further, in a case where the total number of printed sheets of the target printer 4 exceeds the upper limit number, consumables may be provided to the target printer 4 by paying an excess fee.

In the fourth embodiment, as in the second embodiment, when the number of sheets printed in the unit period exceeds the upper limit number in N or more target printers 4, the print application 31B performs the process for temporarily changing the plan of the print service from the first plan to the second plan.

Hereinafter, the print system 1 of the fourth embodiment will be described focusing on differences from the third embodiment.

In the fourth embodiment, the print application 31B performs a plan change process (see FIG. 3) similar to that of the third embodiment in order to temporarily change the plan of the print service. However, in the fourth embodiment, since the plurality of printers 4 are targets of the print service, a part of the plan change process is different from that of the third embodiment. The plan change process of the fourth embodiment will be described below with reference to FIG. 3, focusing on the differences from the third embodiment.

In S100, the print application 31B receives the history information 40D from each target printer 4, and, based on these history information 40D, acquires the total number of printed sheets in the past unit periods, the current number of printed sheets, and the remaining number of sheets for each target printer 4.

In S105, the print application 31B determines, for each target printer 4, whether a notification condition similar to that of the third embodiment is satisfied. In a case where the notification condition is satisfied for N or more target printers 4 (S105: YES), the print application 31B proceeds to S110. In a case where the notification condition is not satisfied for N or more target printers 4 (S105: NO), the print application 31B proceeds to S120.

In S110, the print application 31B performs a process similar to that of the third embodiment. The notification procedure of the fourth embodiment is different from that of the third embodiment in that the notification may be performed via the plurality of target printers 4.

In S115, similarly to the second embodiment, the print application 31B notifies that printing in the target printers 4 is restricted in the current unit period. The print application 31B notifies about the target printer 4 having a relatively large remaining number of sheets, and suggests printing in the target printer 4. The notification and the suggestion are performed by a notification procedure similar to that of S110.

In S120, the print application 31B determines whether the change condition is satisfied, as in the second embodiment. In S125 and S130, in a case where the subscriber's confirmation is obtained, the print application 31B temporarily changes the plan of the print service from the first plan to the second plan.

In the fourth embodiment, the print application 31B performs a plan return process (see FIG. 4) similar to that of the third embodiment, in order to return the temporarily changed plan of the print service from the second plan to the first plan.

A fifth embodiment will be described. The print system 1 of the fifth embodiment is different from the first embodiment in that the plan change process and the plan return process are performed by the print program 40C of the printer 4 which is a target of the print service in which the plan is changed in these processes (see FIGS. 1A to 2A, 3, 4, and 5B). However, the other parts of the print system 1 are the same as those of the first embodiment.

In the fifth embodiment, the CPU 40A of the controller 40 of the printer 4 operates in accordance with the print program 40C of the printer 4 to perform the plan change process and the plan return process. Hereinafter, for convenience, the processing performed by the CPU 40A under the control of the print program 40C may be described as being performed by the print program 40C itself.

The printer 4 of the fifth embodiment is different from the first embodiment in that management information 40E is stored in the memory 40B (see FIG. 5B). The management information 40E is information relating to the print service. The management information 40E may include the name and contact information of the subscriber, the print service to which the subscriber subscribes and the plan of the print service, and the model name and identification information of the target printer 4 of the print service.

The printer 4 of the fifth embodiment includes a first communication interface 45 and a second communication interface 46, instead of the communication interface 44. The first communication interface 45 is a unit for communicating with the information processing apparatus 3. The first communication interface 45 may communicate with the information processing apparatus 3 via a local area network, for example, or may directly communicate with the information processing apparatus 3 in accordance with a standard such as USB or Bluetooth, for example.

The second communication interface 46 is a unit for accessing the wide area network 5, and communicates with, for example, an apparatus such as the operation server 2 via the wide area network 5.

The print system 1 of the fifth embodiment will be described below, while focusing on the differences from the first embodiment.

Next, a plan change process performed by the print program 40C will be described with reference to the flowchart of FIG. 3. The plan change process of the fifth embodiment is similar to that of the first embodiment, but is different from that of the first embodiment in that the plan change process is performed by the print program 40C and in part of the process. The plan change process of the fifth embodiment will be described below, focusing on the differences from the first embodiment.

In S100, the print program 40C acquires the total number of printed sheets in the past unit periods, the current number of printed sheets, and the remaining number of sheets, based on the history information 40D.

In S105, the print program 40C determines whether a notification condition similar to that of the first embodiment is satisfied. In a case where the notification condition is a condition that it is predicted the total number of printed sheets in the current unit period exceeds the first upper limit number, the print program 40C may perform the prediction based on the history information 40D. Alternatively, for example, the print program 40C may predict whether the total number of printed sheets in the current unit period exceeds the first upper limit number based on the planned print number of sheets. In this case, the print program 40C may acquire the planned print number of sheets based on an operation received via the input interface 43. Further, the planned print number of sheets may be acquired based on an operation received from the user in the target information processing apparatus 3, and the print program 40C may receive the planned print number of sheets from the target information processing apparatus 3.

In S110, the print program 40C performs a process similar to that of the first embodiment. In the notification procedure of the fifth embodiment, the print program 40C may perform notification via the display 42 or a speaker (not shown), or may transmit a command to the target information processing apparatus 3 and perform notification via the display 32 or a speaker (not shown) of the target information processing apparatus 3. In the confirmation procedure of the fifth embodiment, the print program 40C may query by the above-described notification procedure. The print program 40C may receive a response to the query from the subscriber via the input interface 43. Further, the target information processing apparatus 3 may receive a response from the subscriber via the input interface 33, and the print program 40C may receive the response from the target information processing apparatus 3.

In S115, similarly to the first embodiment, the print program 40C notifies that printing in the current unit period in the printer 4 in which the print program 40C is installed is restricted, by the notification procedure described above.

In S120, the print program 40C determines whether a change condition similar to that of the first embodiment is satisfied. That is, the change condition may be, for example, a condition that the current number of printed sheets exceeds the first upper limit number. In this case, the print program 40C may determine whether the change condition is satisfied based on the history information 40D. Alternatively, the change condition may be a condition that the current number of printed sheets exceeds the first upper limit number and the excess fee in the current unit period is larger than the price difference of the basic fee. In this case, the print program 40C may calculate the excess number of sheets based on the history information 40D, and may calculate the excess fee based on the excess number of sheets and price information received from the management program 22B, for example.

In S125, the print program 40C determines whether the subscriber has agreed to change the plan of the print service from the first plan to the second plan, based on the response received in S110.

In S130, the print program 40C transmits a command to the management program 22B to instruct the management program 22B to temporarily change the plan of the print service from the first plan to the second plan, and ends the process. The print program 40C updates the management information 40E so as to reflect the temporary change from the first plan to the second plan of the print service. The management program 22B that has received the command changes the management information of the print service, thereby temporarily changing the plan of the print service from the first plan to the second plan.

Next, a plan return process performed by the print program 40C will be described with reference to the flowchart of FIG. 4. The plan return process of the fifth embodiment is similar to that of the first embodiment, but is different from that of the first embodiment in that the plan return process is performed by the print program 40C and in part of the process. The plan return process of the fifth embodiment will be described below, focusing on the differences from the first embodiment.

In S200, the print program 40C determines whether it is the start time of a new unit period. In S205, the print program 40C determines whether the plan of the print service has been temporarily changed from the first plan to the second plan by the plan change process, based on the management information 40E.

In S210, the print program 40C queries the subscriber whether to agree to return the plan of the print service from the second plan to the first plan by the confirmation procedure described above, and receives a response to the query.

In S215, the print program 40C transmits a command to the management program 22B to instruct the management program 22B to return the plan of the print service from the second plan to the first plan, and updates the management information 40E accordingly, and ends the process.

In S220, the print program 40C transmits a command to the management program 22B to instruct the management program 22B to continue the second plan of the print service, and updates the management information 40E accordingly, and ends the process.

The management program 22B that has received the command changes the management information of the print service, and thereby, in response to an instruction from the print program 40C, returns the plan of the print service from the second plan to the first plan, or continues the second plan.

A sixth embodiment will be described. The print system 1 of the sixth embodiment is different from that of the fifth embodiment in that a plurality of printers 4 are targets of one print service, but the other parts are the same as those of the fifth embodiment (see FIGS. 1A to 2A, 3, 4, and 5B). That is, the print service of the sixth embodiment is similar to that of the second embodiment. That is, by paying a basic fee, consumables to be used in a unit period are provided to the target printer 4 in which the total number of printed sheets in the unit period does not exceed the upper limit number, among the plurality of target printers 4. Further, in a case where the total number of printed sheets of the target printer 4 exceeds the upper limit number, consumables may be provided to the target printer 4 by paying an excess fee.

In the sixth embodiment, as in the second embodiment, when the number of printed sheets in the unit period exceeds the upper limit number in N or more target printers 4, the print program 40C performs the process for temporarily changing the plan of the print service from the first plan to the second plan.

Hereinafter, the print system 1 of the sixth embodiment will be described focusing on differences from the fifth embodiment.

In the sixth embodiment, the print program 40C performs a plan change process (see FIG. 3) similar to that of the fifth embodiment in order to temporarily change the plan of the print service. However, in the sixth embodiment, since the plurality of target printers 4 are targets of the print service, a part of the plan change process is different from that of the fifth embodiment. The plan change process of the sixth embodiment will be described below with reference to FIG. 3, focusing on the differences from the fifth embodiment.

In S100, the print program 40C receives the history information 40D from other target printers 4 other than the target printer 4 in which the print program 40C is installed (hereinafter referred to as a control printer 4). The print program 40C acquires the total number of printed sheets in the past unit periods, the current number of printed sheets, and the remaining number of sheets for each target printer 4, based on the history information 40D of the control printer 4 and the history information 40D of the other target printers 4.

In S105, the print program 40C determines, for each target printer 4, whether a notification condition similar to that of the fifth embodiment is satisfied. In a case where the notification condition is satisfied for N or more target printers 4 (S105: YES), the print program 40C proceeds to S110. In a case where the notification condition is not satisfied for N or more target printers 4 (S105: NO), the print program 40C proceeds to S120.

In S110, a process similar to that of the fifth embodiment is performed. The notification procedure of the sixth embodiment differs from that of the fifth embodiment in that notification may be performed via the plurality of target printers 4.

In S115, similarly to the second embodiment, the print program 40C notifies that printing in the target printer 4 is restricted in the current unit period, and notifies about the target printer 4 having a relatively large remaining number of sheets, and suggests printing in the target printer 4. The notification and the suggestion are performed by a notification procedure similar to that of S110.

In S120, the print program 40C determines whether the change condition is satisfied, as in the second embodiment. In S125 and S130, in a case where the subscriber's confirmation is obtained, the print program 40C temporarily changes the plan of the print service from the first plan to the second plan.

In the sixth embodiment, the print program 40C also performs a plan return process (see FIG. 4) similar to that of the fifth embodiment in order to return the temporarily changed plan of the print service from the second plan to the first plan.
(1) According to the above-described embodiments, in a case where the current number of printed sheets exceeds the first upper limit number, the plan of the print service in the unit period may be temporarily changed from the first plan to the second plan. Thus, the print service is provided in a manner appropriate for the subscriber.
(2) When the unit period in which the plan is temporarily changed to the second plan ends, the print service is returned to the first plan originally selected by the subscriber. Thus, the print service is provided in accordance with a desire of the subscriber.
(3) When the notification condition is satisfied, in S110 of the plan change process, it is notified that the plan of the current unit period may be temporarily changed from the first plan to the second plan. Thus, when the plan is changed due to the change condition being satisfied, the subscriber is notified of the change. Thus, the plan is changed appropriately.
(4) An example of the notification condition is that the current number of printed sheets exceeds the first upper limit number. By using such notification condition, the change of the plan of the print service is notified at a suitable timing.
(5) An example of the notification condition is that the remaining number of sheets in the current unit period reaches the lower limit number. By using such notification condition, the change of the plan of the print service is notified at a suitable timing.
(6) In S110 of the plan change process, the remaining number of sheets in the current unit period is notified. This allows the subscriber to grasp the time and possibility of plan change, thus improving convenience.
(7) An example of the notification condition is that it is predicted that the total number of printed sheets in the current unit period exceeds the first upper limit number, based on the planned print number of sheets by the subscriber. By using such notification condition, the change of the plan of the print service is notified at a suitable timing.
(8) An example of the notification condition is that it is predicted that the total number of printed sheets in the current unit period exceeds the first upper limit number, based on the total number of printed sheets in the past unit periods. By using such notification condition, the change of the plan of the print service is notified at a suitable timing.
(9) In a case where the current number of printed sheets exceeds the first upper limit number and the excess fee in the current unit period exceeds the price difference between the basic fee of the second plan and the basic fee of the first plan, the plan of the print service in the unit period may be temporarily changed. This enables a change of the plan of the print service at a timing when a cost merit is generated for the subscriber.
(10) In S115 of the plan change process of the second, fourth, and sixth embodiments, the target printer 4 having a relatively large remaining number of sheets is notified. This prompts the subscriber to perform printing by the target printer 4 having a large remaining number of sheets.
(11) In S115 of the plan change process, the subscriber is notified that printing by the target printer 4 is restricted. Thus, when the possibility that the number of printed sheets in the current unit period exceeds the first upper limit number becomes high, an alert is performed.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described present disclosure are provided below.
(1) In the plan change process, in a case where the change condition is satisfied, the plan of the print service may be temporarily changed from the first plan to the second plan regardless of the intention of the subscriber (that is, without receiving confirmation from the subscriber). Similarly, in the plan returning process, the plan of the print service that has been temporarily changed may be returned from the second plan to the first plan regardless of the intention of the subscriber (that is, without receiving confirmation from the subscriber).
(2) A plurality of functions of one component in the above-described embodiments may be realized by a plurality of components, or one function of one component may be realized by a plurality of components. A plurality of functions of a plurality of components may be realized by one component, or one function realized by a plurality of components may be realized by one component. A part of the configurations of the above-described embodiments may be omitted. At least a part of the configuration of one embodiment may be added to or replaced with the configuration of another embodiment.
(3) In addition to the operation server 2, the information processing apparatus 3, and the printer 4 described above, the present disclosure may be implemented in various modes such as a non-transitory computer-readable storage medium such as a semiconductor memory, a hard disk drive, a USB memory, a CD-ROM, or a DVD-ROM storing the management program 22B, the print application 31B, or the print program 40C, and a method corresponding to the plan change process and the plan return process realized by the management program 22B, the print application 31B, or the print program 40C.

In this specification, the term “controller” encompasses both a single controller or a group of multiple controllers located either locally or remotely working together or in a distributed fashion to collectively perform the tasks attributed to the “controller” described herein.

Each of the operation server 2 of the first and second embodiments, the information processing apparatus 3 of the third and fourth embodiments, and the printer 4 of the fifth and sixth embodiments corresponds to an example of an electronic device.

In the plan change process of the first to sixth embodiments, S105 corresponds to an example of a prediction process, S110 corresponds to an example of a change notification process, S115 corresponds to an example of a restriction notification process, S120 corresponds to an example of a number-of-sheets determination process and a fee determination process, and S130 corresponds to an example of a change process.

In the plan return process of the first to sixth embodiments, S215 corresponds to an example of a change process. In the plan change process of the second, fourth, and sixth embodiments, S115 corresponds to an example of a print notification process.

What is claimed is:

1. A non-transitory computer-readable storage medium storing a set of program instructions for an electronic device comprising a controller, the set of program instructions, when executed by the controller, causing the electronic device to perform:
in a case where a number of printed sheets in a printer in a current unit period satisfies a particular condition, notifying about a change of a plan of a print service from a first plan to a second plan, the printer being a target of the print service, the print service having a plurality of plans including the first plan and the second plan, the particular condition being a condition of a number of sheets relating to the first plan corresponding to the current unit period,
any one of the plurality of plans of the print service being set to each of unit periods including the current unit period,
each of the plurality of plans having an upper limit number of sheets,
each of the plurality of plans having a basic fee corresponding to the upper limit number such that the basic fee increases as the upper limit number increases,
the print service being that a consumable to be used in the printer in a unit period is provided by paying the basic fee of the plan corresponding to the unit period, in a case where the number of printed sheets at an end of the unit period does not exceed the upper limit number of the plan,
the first plan having a first upper limit number as the upper limit number, the second plan having a second upper limit number as the upper limit number, the second upper limit number being larger than the first upper limit number.

2. The non-transitory computer-readable storage medium according to claim 1, wherein the set of program instructions, when executed by the controller, causes the electronic device to perform:
changing the plan of the print service corresponding to a subsequent unit period from the second plan to the first plan, the subsequent unit period being a unit period immediately after the current unit period.

3. The non-transitory computer-readable storage medium according to claim 1, wherein the set of program instructions, when executed by the controller, causes the electronic device to perform:
querying whether to agree to the change of the plan;
receiving confirmation of whether to agree to the change of the plan; and
changing the plan in response to receiving the confirmation to agree to the change of the plan.

4. The non-transitory computer-readable storage medium according to claim 1, wherein the notifying is performed in a case where the number of printed sheets in a middle of the current unit period exceeds the first upper limit number.

5. The non-transitory computer-readable storage medium according to claim 1, wherein the notifying is performed in a case where a remaining number of sheets reaches a particular lower limit number, the remaining number of sheets being a difference between the first upper limit number and the number of printed sheets in the current unit period.

6. The non-transitory computer-readable storage medium according to claim 1, wherein the notifying further includes notifying a remaining number of sheets that is a difference between the first upper limit number and the number of printed sheets in the current unit period.

7. The non-transitory computer-readable storage medium according to claim 1, wherein the set of program instructions, when executed by the controller, causes the electronic device to perform:
acquiring a planned print number of sheets that is a number of sheets to be used in printing in the printer in the current unit period;
predicting whether the number of printed sheets at an end of the current unit period exceeds the first upper limit number, based on the acquired planned print number of sheets; and
notifying about the change of the plan from the first plan to the second plan in a case where it is predicted that the number of printed sheets at the end of the current unit period exceeds the first upper limit number.

8. The non-transitory computer-readable storage medium according to claim 1, wherein the set of program instructions, when executed by the controller, causes the electronic device to perform:
predicting whether the number of printed sheets at an end of the current unit period exceeds the first upper limit number, based on the number of printed sheets in a unit period before the current unit period; and
notifying about the change of the plan from the first plan to the second plan in a case where it is predicted that the number of printed sheets at the end of the current unit period exceeds the first upper limit number.

9. The non-transitory computer-readable storage medium according to claim 1, wherein the print service is that, in a case where the number of printed sheets in a unit period exceeds the upper limit number of the plan corresponding to the unit period, a consumable to be used in the unit period is provided by paying an excess fee corresponding to an excess number of sheets, the excess number of sheets being a difference between the number of printed sheets and the upper limit number; and
wherein the set of program instructions, when executed by the controller, causes the electronic device to perform:
in a case where the number of printed sheets in a middle of the current unit period exceeds the upper limit number of the first plan, determining whether the excess fee corresponding to the excess number of sheets in the current unit period is higher than a price difference obtained by subtracting the basic fee of the first plan from the basic fee of the second plan; and
in a case where the number of printed sheets exceeds the first upper limit number and where the excess fee is higher than the price difference, changing the plan of the print service from the first plan to the second plan.

10. The non-transitory computer-readable storage medium according to claim 1, wherein a plurality of printers including the printer are targets of the print service, the print service being that, by paying the basic fee of the plan, a consumable to be used in a unit period is provided for a printer, among the plurality of printers, in which the number of printed sheets at an end of the unit period does not exceed the upper limit number;
wherein the set of program instructions, when executed by the controller, causes the electronic device to perform:
determining, for each of the plurality of printers, whether the number of printed sheets in a middle of the current unit period exceeds the first upper limit number;
in a case where the number of printed sheets in the middle of the current unit period exceeds the first upper limit number for a particular number of the plurality of printers, changing the plan of the print service from the first plan to the second plan; and
notifying about a printer having a relatively large remaining number of sheets among the plurality of printers, the remaining number of sheets being a difference between the first upper limit number and the number of printed sheets in the current unit period.

11. The non-transitory computer-readable storage medium according to claim 1, wherein the set of program instructions, when executed by the controller, causes the electronic device to perform:
notifying that printing is restricted in a case where a remaining number of sheets reaches a particular lower limit number, the remaining number of sheets being a difference between the first upper limit number and the number of printed sheets in the current unit period.

12. An electronic device comprising:
a controller configured to perform:
in a case where a number of printed sheets in a printer in a current unit period satisfies a particular condition, notifying about a change of a plan of a print service from a first plan to a second plan, the printer being a target of the print service, the print service having a plurality of plans including the first plan and the second plan, the particular condition being a condition of a number of sheets relating to the first plan corresponding to the current unit period,
any one of the plurality of plans of the print service being set to each of unit periods including the current unit period,
each of the plurality of plans having an upper limit number of sheets,
each of the plurality of plans having a basic fee corresponding to the upper limit number such that the basic fee increases as the upper limit number increases,
the print service being that a consumable to be used in the printer in a unit period is provided by paying the basic fee of the plan corresponding to the unit period, in a case where the number of printed sheets at an end of the unit period does not exceed the upper limit number of the plan,
the first plan having a first upper limit number as the upper limit number, the second plan having a second upper limit number as the upper limit number, the second upper limit number being larger than the first upper limit number.

13. The electronic device according to claim 12, wherein the controller is configured to perform:
changing the plan of the print service corresponding to a subsequent unit period from the second plan to the first plan, the subsequent unit period being a unit period immediately after the current unit period.

14. The electronic device according to claim 12, wherein the controller is configured to perform:
querying whether to agree to the change of the plan;
receiving confirmation of whether to agree to the change of the plan; and
changing the plan in response to receiving the confirmation to agree to the change of the plan.

15. A method performed in an electronic device including a controller, the method comprising:
in a case where a number of printed sheets in a printer in a current unit period satisfies a particular condition, notifying about a change of a plan of a print service from a first plan to a second plan, the printer being a target of the print service, the print service having a plurality of plans including the first plan and the second plan, the particular condition being a condition of a number of sheets relating to the first plan corresponding to the current unit period,
any one of the plurality of plans of the print service being set to each of unit periods including the current unit period,
each of the plurality of plans having an upper limit number of sheets,
each of the plurality of plans having a basic fee corresponding to the upper limit number such that the basic fee increases as the upper limit number increases,
the print service being that a consumable to be used in the printer in a unit period is provided by paying the basic fee of the plan corresponding to the unit period, in a case where the number of printed sheets at an end of the unit period does not exceed the upper limit number of the plan,
the first plan having a first upper limit number as the upper limit number, the second plan having a second upper limit number as the upper limit number, the second upper limit number being larger than the first upper limit number.

16. The method according to claim 15, further comprising:
changing the plan of the print service corresponding to a subsequent unit period from the second plan to the first plan, the subsequent unit period being a unit period immediately after the current unit period.

17. The method according to claim 15, further comprising:
querying whether to agree to the change of the plan;
receiving confirmation of whether to agree to the change of the plan; and
changing the plan in response to receiving the confirmation to agree to the change of the plan.

18. A print system comprising:
an information processing apparatus;
a printer configured to perform printing in accordance with an instruction from the information processing apparatus, the printer being a target of a print service having a plurality of plans including a first plan and a second plan; and
a server configured to perform a process for providing the print service, the server comprising:
a communication interface; and
a controller configured to perform:
receiving a number of printed sheets in the printer in a current unit period, via the communication interface, from the printer or the information processing apparatus; and
in a case where the number of printed sheets in the printer in the current unit period satisfies a particular condition, transmitting a notifying command via the communication interface to the printer or the information processing apparatus, the notifying command being a command for notifying about a change of a plan of a print service from a first plan to a second plan, the printer being a target of the print service, the print service having a plurality of plans including the first plan and the second plan, the particular condition being a condition of a number of sheets relating to the first plan corresponding to the current unit period,
any one of the plurality of plans of the print service being set to each of unit periods including the current unit period,
each of the plurality of plans having an upper limit number of sheets,
each of the plurality of plans having a basic fee corresponding to the upper limit number such that the basic fee increases as the upper limit number increases,
the print service being that a consumable to be used in the printer in a unit period is provided by paying the basic fee of the plan corresponding to the unit period, in a case where the number of printed sheets at an end of the unit period does not exceed the upper limit number of the plan,
the first plan having a first upper limit number as the upper limit number, the second plan having a second upper limit number as the upper limit number, the second upper limit number being larger than the first upper limit number.

19. The print system according to claim 18, wherein the controller is configured to perform:
changing the plan of the print service corresponding to a subsequent unit period from the second plan to the first plan, the subsequent unit period being a unit period immediately after the current unit period.

20. The print system according to claim 18, wherein the controller is configured to perform:
querying whether to agree to the change of the plan by performing communication with the printer or the information processing apparatus;
receiving confirmation of whether to agree to the change of the plan by performing communication with the printer or the information processing apparatus; and
changing the plan in response to receiving the confirmation to agree to the change of the plan.
